(19) United States
(12) Patent Application Publication
(10) Pub. No.: US 2020/0299140 A1
(43) Pub. Date: Sep. 24, 2020

(54) METHOD FOR PREPARING NITROGEN-CONTAINING ACTIVATED CARBON THROUGH AMMONIA ACTIVATION

(71) Applicant: Nanjing Forestry University, Nanjing (CN)

(72) Inventors: Songlin ZUO, Nanjing (CN); Wenbin ZHANG, Nanjing (CN); Yongfang WANG, Nanjing (CN)

(73) Assignee: Nanjing Forestry University, Nanjing (CN)

(21) Appl. No.: 16/308,750

(22) PCT Filed: Sep. 8, 2017
(86) PCT No.: PCT/CN2017/101025

§ 371 Date: Dec. 10, 2018

(51) Int. Cl. C01B 32/318; C01B 32/336

(52) U.S. Cl. CPC C01B 32/318; C01B 32/336

(57) ABSTRACT

The present invention provides a method for preparing nitrogen-containing activated carbon through ammonia activation, including: heating a carbonaceous raw material up to a switching temperature under a protective atmosphere; switching the protective atmosphere to an activator atmosphere at the switching temperature, and then heating up to an activation temperature; and carrying out an activation reaction at the activation temperature to obtain the nitrogen-containing activated carbon; where the protective atmosphere is one or more of nitrogen, argon and ammonia; and the activator atmosphere includes ammonia. In the present invention, the carbonaceous raw material is directly activated under the activator atmosphere, and nitrogen in ammonia and carbon in the raw material undergo an activation reaction to obtain the nitrogen-containing activated carbon. The method is extremely simple and convenient to operate, easy to implement, and has a relatively low cost.

### TECHNICAL FIELD

The present invention relates to the technical field of activated carbon, and in particular to a method for preparing nitrogen-containing activated carbon through ammonia activation.

### BACKGROUND

The activated carbon is a porous carbonaceous material with a well-developed pore structure, which has excellent thermal and chemical stability and is widely used in the fields of environmental protection, electronics, energy sources, chemical industry, food and pharmaceuticals. From the perspective of basic properties of the activated carbon, the application performance of the activated carbon mainly depends on its pore structure and surface chemical properties, and its surface chemical properties depend on the types of constituent minor elements other than carbon elements and the bonding manner of these minor elements with the carbon elements. The activated carbon can be divided into oxygen-containing activated carbon and nitrogen-containing activated carbon according to the types of the main minor elements contained in the activated carbon.

The nitrogen-containing activated carbon not only has the energy storage and energy conversion capabilities similar to those of an advanced nano-carbon material, but also exhibits an unique catalytic ability and an excellent ability of selectively adsorbing acidic ingredients such as CO₂ due to the electron-rich and alkaline properties of nitrogen-containing groups such as pyridine, pyrrole and quaternary nitrogen in the carbon structure.

Currently, the method for preparing the nitrogen-containing activated carbon in the prior art mainly carries out surface modification on the activated carbon by adopting plasma treatment, impregnation of a nitrogen-containing compound and the like, thereby achieving the purpose of introducing a nitrogen element. However, adopting the surface modification manner requires the use of a modification reagent and a more complicated modification process of which the operation is more complicated, thereby greatly increasing the preparation cost.

### SUMMARY

In order to overcome the above disadvantages of the prior art, the present invention provides a method for preparing nitrogen-containing activated carbon through ammonia activation. In the present invention, the nitrogen-containing activated carbon can be obtained just by directly activating a carbonaceous raw material in an activator atmosphere, and the method is extremely simple and convenient to operate, easy to implement and has a relatively low cost.

To solve the above-mentioned technical problems, the technical solution adopted by the present invention is:

A method for preparing nitrogen-containing activated carbon through ammonia activation, including the steps of:

heating a carbonaceous raw material up to a switching temperature under a protective atmosphere, where the protective atmosphere is provided by one or more of nitrogen, argon and ammonia, where the switching temperature is greater than or equal to 700° C. and less than or equal to an activation temperature;

switching the protective atmosphere to an activator atmosphere at the switching temperature, where the activator atmosphere includes ammonia; and

carrying out an activation reaction of the carbonaceous raw material at the activation temperature to obtain the nitrogen-containing activated carbon.

Preferably, the activator atmosphere further includes an inert gas.

Preferably, the volume content of ammonia in the activator atmosphere is greater than or equal to 50%.

Preferably, the activation temperature is 800-1100° C.

Preferably, the time of the activation reaction is 0.5-5 h.

Preferably, the carbonaceous raw material is one or more of biomass based carbon, nitrogen-free activated carbon, coal and charcoal of a polymer material.

Preferably, the biomass based carbon is one or more of wood charcoal, bamboo charcoal, nut-shell charcoal, and straw charcoal.

Preferably, the polymer material is one or more of a rubber, a phenolic resin, an epoxy resin and polyurethane.

Preferably, the particle size of the carbonaceous raw material is ≤80 meshes.

Preferably, the heating rate at which the carbonaceous raw material is heated up to the switching temperature is 1-10° C./min.

Preferably, the heating rate at which the switching temperature is raised to the activation temperature is 1-10° C./min.

The present invention provides a method for preparing nitrogen-containing activated carbon through ammonia activation, including: heating a carbonaceous raw material up to a switching temperature under a protective atmosphere; switching the protective atmosphere to an activator atmosphere at the switching temperature, and then heating up to an activation temperature; and carrying out an activation reaction at the activation temperature to obtain the nitrogen-containing activated carbon; where the protective atmosphere is one or more of nitrogen, argon and ammonia; and the activator atmosphere includes ammonia. In the present invention, the carbonaceous raw material is directly activated under the activator atmosphere, and nitrogen in ammonia and carbon in the raw material undergo an activation reaction to obtain the nitrogen-containing activated carbon. The method is extremely simple and convenient to operate, easy to implement, and has a relatively low cost.

The nitrogen-containing activated carbon obtained by the present invention includes nitrogen-containing groups such as pyridine, pyrrole, quaternary nitrogen, and the like, and has the characteristics of a high specific surface area, a high total pore volume and a high nitrogen content. In particular, the specific surface area can reach 2,321 m²/g, the total pore volume can reach 1.476 cm³/g, and the nitrogen content can reach 7.17%.

### DETAILED DESCRIPTION

The present invention provides a method for preparing nitrogen-containing activated carbon through ammonia activation, including the steps of:

heating a carbonaceous raw material up to a switching temperature under a protective atmosphere, where the protective atmosphere is provided by one or more of nitrogen, argon and ammonia; and the switching temperature is greater than or equal to 700° C. and less than or equal to an activation temperature;

switching the protective atmosphere to an activator atmosphere at the switching temperature, where the activator atmosphere includes ammonia; and

carrying out an activation reaction of the carbonaceous raw material at the activation temperature to obtain the nitrogen-containing activated carbon.

In the present invention, the carbonaceous raw material is heated up to the switching temperature under the protective atmosphere. In the present invention, the carbonaceous raw material is preferably one or more of biomass based carbon, nitrogen-free activated carbon, coal, and charcoal of a polymer material. In the present invention, the biomass based carbon is preferably one or more of wood charcoal, bamboo charcoal, nut-shell charcoal, and straw charcoal. In the present invention, the charcoal of a polymer material refers to carbon obtained by carbonizing the polymer material; and the polymer material is preferably one or more of a rubber, a phenolic resin, an epoxy resin and polyurethane. In the present invention, a carbonizing operation well known to those skilled in the art can be used. In the present invention, when the carbonaceous raw material is preferably a mixture of a variety of substances in the aforementioned specific selection, the substances are preferably mixed by equal mass.

In the present invention, the particle size of the carbonaceous raw material is preferably 80 meshes (0.178 mm), more preferably 60 meshes (0.425 mm), and most preferably 40 meshes (0.250 mm).

The present invention has no special requirement on the source of the carbonaceous raw material, and a commercially available product of the aforementioned specific substance well known to those skilled in the art can be used. In the present invention, when the carbonaceous raw material is a nitrogen-free activated carbon raw material, the nitrogen-containing activated carbon obtained by processing a commercially-available conventional nitrogen-free activated carbon raw material with the method of the present application contains nitrogen and has a more developed pore structure.

In the present invention, preferably the carbonaceous raw material is placed into an activation device with the protective atmosphere located therein, such that the carbonaceous raw material is heated up under the protective atmosphere. In the present invention, the activation device is preferably a commercially available fixed-bed activation furnace, activation converter, multi-tube furnace or fluidized furnace which is well known to those skilled in the art. In the present invention, the protective atmosphere is one or more of nitrogen, argon and ammonia; and when the protective atmosphere is preferably two or three of nitrogen, argon and ammonia, the mixed gas is preferably a mixture of ammonia with other gases. In the present invention, when the protective atmosphere is nitrogen and/or argon, such an inert atmosphere can protect the carbonaceous raw material from any reaction during the heating-up period; and when the protective atmosphere is ammonia, or a mixed gas of ammonia with one or both of nitrogen and argon, the atmosphere replacement steps during subsequent activation can be reduced and the operation is simplified.

The present invention has no special requirement on the heating-up manner, and a heating-up manner well known to those skilled in the art can be used. In a specific embodiment of the present invention, the heating rate of the heating-up is preferably 1-10° C./min, and more preferably 5° C./min.

In the present invention, after the temperature is raised to the switching temperature, the protective atmosphere is switched to the activator atmosphere at the switching temperature. In the present invention, the activator atmosphere preferably includes ammonia, and more preferably also includes an inert gas. In the present invention, the inert atmosphere is preferably argon and/or nitrogen. In the present invention, when the activator atmosphere includes both of ammonia and the inert gas, the volume content of ammonia in the activator atmosphere is preferably ≥50%, more preferably ≥70%, and most preferably ≥90%. The present invention has no special requirement on the implementation of atmosphere switching, and an implementation well known to those skilled in the art can be used. In the present invention, during the specific implementation, preferably the entire protective atmosphere in the activation device is removed by introducing the activation atmosphere into the activation device. After the atmosphere switching is finished, if the switching temperature is smaller than the activation temperature, then the present invention immediately starts the heating-up operation of the next phase until the temperature is raised to the activation temperature, and the switching temperature does not need to be maintained anymore; and if the switching temperature is equal to the activation temperature, the present invention can directly carry out the activation reaction without further heating-up operation.

In the present invention, the activation temperature is preferably 800-1,100° C., more preferably 850-1,000° C., and most preferably 900° C. The present invention has no special requirement on the heating-up manner used when the switching temperature is raised to the activation temperature, and a heating-up manner well known to those skilled in the art can be used. In a specific embodiment of the present invention, the heating rate of the heating-up in this step is preferably 1-10° C./min, and more preferably 5° C./min.

The present invention carries out the activation reaction at the activation temperature to obtain the nitrogen-containing activated carbon. In the present invention, the time of the activation reaction is preferably 0.5-5 h, more preferably 1-4 h, and most preferably 2-3 h.

In the present invention, after the activation reaction is finished, the nitrogen-containing activated carbon product is taken out from the activation device after the activation device is cooled to room temperature; and for cost considerations, in the present invention the nitrogen-containing activated carbon product is taken out from the activation device after the activation device is cooled to be lower than 500° C., and then the activation device is continually subjected to atmosphere replacement and charging operations, so as to carry out production of the next batch.

The nitrogen-containing activated carbon obtained by the present invention has the characteristics of a high specific surface area, a high total pore volume and a high nitrogen content. In particular, the specific surface area can reach 2,321 m²/g, the total pore volume can reach 1.476 cm³/g, and the nitrogen content can reach 7.17%.

The method for preparing nitrogen-containing activated carbon through ammonia activation as provided by the present invention will be described in detail below in connection with Embodiments, but these Embodiments should not be understood as limiting the claimed scope of the present invention.

### Embodiment 1

Coconut-shell activated carbon (AC) of 40-60 meshes, which was used as the carbonaceous raw material, was placed into a fixed-bed activation furnace, nitrogen was introduced into the furnace and the temperature was raised to the switching temperature by an increment of 5° C./min, then the gas was switched to ammonia, and after the temperature was continuously raised to a predetermined activation temperature, the predetermined activation temperature was kept for 1 h to carry out the activation reaction. After the activation reaction was finished, the activation furnace was cooled to be lower than 500° C., then the nitrogen-containing activated carbon was taken out from the activation furnace, and the yield of ammonia activation was calculated according to the mass ratio of the obtained nitrogen-containing activated carbon to the raw material. The prepared sample was named AC-X, where x represented the activation temperature.

The contents of C, H, N, and O in a nitrogen-containing activated carbon sample were determined by an elemental analyzer of Vario EL cube type available from Elementar at Germany, where the content of O was determined by analytic determination under an oxygen mode. The adsorption-desorption isotherm of the activated carbon was tested by an automatic adsorption instrument of Autosorb-iQ2 type available from Quantachrome. The specific surface area (S_{BET}) of the sample was calculated by a Brunauer-Emmet-Teller (BET) equation, the total pore volume (V-_{Tot}) of the sample was calculated at P/P₀=0.99. The micropore volume (V_{mic}) was calculated by a Du-binin-Radushkevic equation, and the mesopore volume (Vₘₑₛ) was obtained by subtracting the micropore volume from the total pore volume.

TABLE 1
Results of ammonia activation when the coconut-shell activated
carbon was used as the raw material

| | | Pore Structure | | | | | | | |
|---|---|---|---|---|---|---|---|---|---|
| | | S_{BET} | V_{Tot} | V_{mic} | Vₘₑₛ | | | | |
| | Yield, | (m²/ | (cm³/ | (cm³/ | (cm³/ | Element Content, % | | | |
| Sample | % | g) | g) | g) | g) | C | N | O | H |
| AC | / | 1508 | 0.732 | 0.561 | 0.171 | 88.57 | 0.59 | 8.80 | 0.70 |
| AC-800 | 94.67 | 1666 | 0.811 | 0.773 | 0.038 | 88.95 | 3.71 | 4.69 | 0.87 |
| AC-850 | 90.67 | 1699 | 0.830 | 0.794 | 0.036 | 87.82 | 4.00 | 4.67 | 0.64 |
| AC-900 | 80.00 | 1945 | 1.010 | 0.943 | 0.067 | 88.07 | 4.27 | 4.14 | 0.57 |
| AC-950 | 72.00 | 1941 | 0.987 | 0.950 | 0.037 | 90.80 | 3.89 | 4.10 | 0.56 |
| AC-1000 | 55.92 | 2241 | 1.233 | 1.130 | 0.103 | 89.31 | 3.61 | 3.79 | 0.57 |

It could be seen from table 1 that, the yield of the nitrogen-containing activated carbon was continually decreased with the increasing of the ammonia activation temperature, and meanwhile the pore structure was continually developed, had a specific surface area and a specific pore volume which were increased significantly, and a mesopore volume which was not obvious; and the content of a nitrogen element in the activated carbon could reach more than 3.6%, indicating that ammonia activation introduced rich nitrogen-containing groups into the activated carbon.

### Embodiment 2

Wood charcoal (WC) of 20-60 meshes, which was used as the carbonaceous raw material, was placed into a fixed-bed activation furnace, nitrogen was introduced into the furnace and the temperature was raised to 700° C. by an increment of 5° C./min, then ammonia was introduced into the furnace, and after the temperature was raised to a predetermined activation temperature, the temperature was kept for 1 h to carry out the activation reaction. After the activation reaction was finished, the activation furnace was cooled to be lower than 500° C., then the nitrogen-containing activated carbon was taken out from the activation furnace, and the yield of ammonia activation was calculated according to the mass ratio of the obtained nitrogen-containing activated carbon to the raw material. The prepared sample was named WC-X, where X represented the activation temperature.

The elemental contents and pore structures of the wood charcoal and the nitrogen-containing activated carbon were analyzed by the same method as in Embodiment 1. The result of this embodiment is shown in table 2.

TABLE 2
Results of ammonia activation when the wood charcoal
was used as the raw material

| | Yield, | Pore Structure | | | | Element Content, % | | | |
|---|---|---|---|---|---|---|---|---|---|
| Sample | % | S_{BET} (m² · g⁻¹) | V_{T} (cm³ · g⁻¹) | V_{mic} (cm³/g) | Vₘₑₛ (cm³/g) | C | N | O | H |
| Wood | / | 124 | 0.085 | 0.057 | 0.028 | 90.68 | 1.53 | 7.49 | 2.42 |
| Charcoal | | | | | | | | | |
| WC-800 | 80.7 | 702 | 0.332 | 0.287 | 0.045 | 89.33 | 7.17 | 5.81 | 0.98 |
| WC-850 | 69.3 | 1064 | 0.476 | 0.437 | 0.039 | 90.89 | 6.52 | 5.38 | 0.98 |
| WC-900 | 50.7 | 1239 | 0.564 | 0.533 | 0.031 | 88.83 | 6.39 | 5.25 | 0.92 |
| WC-950 | 25.3 | 1431 | 0.757 | 0.705 | 0.052 | 87.83 | 5.69 | 5.47 | 0.80 |
| WC-1000 | 24.0 | 2316 | 1.476 | 1.133 | 0.343 | 89.14 | 5.02 | 4.86 | 0.63 |
| WC-1050 | 16.7 | 2221 | 1.399 | 1.272 | 0.127 | 88.58 | 3.72 | 4.01 | 0.47 |
| WC-1100 | 16.0 | 1994 | 1.215 | 1.063 | 0.152 | 90.82 | 3.12 | 3.44 | 0.39 |

As could be seen from table 2, ammonia could activate the wood charcoal significantly, to prepare nitrogen-containing activated carbon with a highly-developed pore structure, of which the content of the nitrogen element could between 3-7%. Nitrogen-containing activated carbon with a high specific surface area of over 2,300 m²·g⁻¹ could be prepared by activating the wood charcoal with a specific surface area of only 124 m²·g⁻¹ with ammonia at 1000° C.

### Embodiment 3

Coconut-shell charcoal (YC) of 40-60 meshes, which was used as the carbonaceous raw material, was placed into a fixed-bed activation furnace, nitrogen was introduced into the furnace and the temperature was raised to 700° C. by an increment of 5° C./min, then ammonia was introduced into the furnace, and after the temperature was raised to 1,000° C., the temperature was kept for a predetermined time (the activation time) to carry out the activation reaction. After the activation reaction was finished, the activation furnace was cooled to be lower than 500° C., then the nitrogen-containing activated carbon was taken out from the activation furnace, and the yield of ammonia activation was calculated according to the mass ratio of the obtained nitrogen-containing activated carbon to the raw material. The prepared sample was named YC-X, where X represented the activation time (in min).

The elemental contents and pore structures of the coconut-shell charcoal and the activated carbon were analyzed by the same method as in Embodiment 1. The result of this embodiment is shown in table 3.

TABLE 3
Results of ammonia activation when the coconut-shell charcoal
was used as the raw material

| | Yield, | Pore Structure | | | | Element Content, % | | | |
|---|---|---|---|---|---|---|---|---|---|
| Sample | % | S_{BET} (m² · g⁻¹) | V_{T} (cm³ · g⁻¹) | V_{mic} (cm³/g) | Vₘₑₛ (cm³/g) | C | N | O | H |
| Coconut | / | 785 | 0.359 | 0.316 | 0.043 | 88.14 | 1.58 | 4.23 | 0.81 |
| Shell | | | | | | | | | |
| Charcoal | | | | | | | | | |
| YC-30 | 72.0 | 1418 | 0.628 | 0.605 | 0.023 | 87.17 | 3.73 | 3.84 | 0.68 |
| YC-70 | 45.3 | 1931 | 0.989 | 0.968 | 0.021 | 86.31 | 3.88 | 4.07 | 0.62 |
| YC-120 | 24.0 | 2321 | 1.390 | 1.146 | 0.244 | 85.07 | 4.06 | 2.09 | 0.69 |
| YC-180 | 10.9 | 2131 | 1.143 | 1.069 | 0.074 | 82.76 | 4.25 | 2.11 | 0.59 |

As can be seen from table 3, the activated carbon with a specific surface area of 2,300 m²·g⁻¹ and a nitrogen content of more than 3.5% could be prepared from the coconut-shell carbon raw material via ammonia activation at 1000° C. The activation time had a significant effect on ammonia activation, and with the extension of time, the activated carbon had a significantly reduced yield and a more-developed pore structure, but an activation time which is too long, i.e., excessive ablation, was adverse to pore development.

### Embodiment 4

Coal (CC) of 40-60 meshes, which was used as the activated carbonaceous raw material, was placed into a fixed-bed activation furnace, nitrogen was introduced into the furnace and the temperature was raised to 700° C. by an increment of 5° C./min, then ammonia was introduced into the furnace, and after the temperature was raised to 1,000° C., the temperature was kept for a predetermined time (the activation time) to carry out the activation reaction. After the activation reaction was finished, the activation furnace was cooled to be lower than 500° C., then the nitrogen-containing activated carbon was taken out from the activation furnace, and the yield of ammonia activation was calculated according to the mass ratio of the obtained nitrogen-containing activated carbon to the raw material. The prepared sample was named CC-X, where X represented the activation time (in min).

The elemental contents and pore structures of the coal and the activated carbon were analyzed by the same method as in Embodiment 1. The result of this embodiment is shown in table 4.

TABLE 4
Results of ammonia activation when the coal was used as the raw material

| | Yield, | Pore Structure | | | | Element Content, % | | | |
|---|---|---|---|---|---|---|---|---|---|
| Sample | % | S_{BET} (m² · g⁻¹) | V_{T} (cm³ · g⁻¹) | V_{mic} (cm³/g) | Vₘₑₛ (cm³/g) | C | N | O | H |
| Coal | / | 31 | 0.030 | 0.010 | 0.020 | 86.42 | 1.93 | 6.14 | 1.94 |
| CC-30 | 88.0 | 91 | 0.070 | 0.043 | 0.027 | 87.46 | 2.10 | 2.51 | 0.68 |
| CC-70 | 86.1 | 201 | 0.111 | 0.087 | 0.024 | 88.29 | 2.21 | 2.48 | 0.70 |
| CC-120 | 74.0 | 306 | 0.169 | 0.140 | 0.029 | 86.99 | 2.43 | 2.28 | 0.68 |
| CC-180 | 60.0 | 607 | 0.307 | 0.267 | 0.040 | 85.41 | 2.80 | 2.44 | 0.50 |

As could be seen from table 4, although via the ammonia activation at 1000° C. the coal had a significantly developed pore structure, the specific surface area of the coal was 607 m²·g⁻¹, and the nitrogen content of the coal was 2.8%.

The above description of the embodiment is only for helping to understand the method of the present invention and its core idea. It should be noted that, several improvements and modifications may be made by persons of ordinary skill in the art without departing from the principle of the present invention, and these improvements and modifications should also be considered within the protection scope of the present invention. Various modifications to these embodiments are readily apparent to persons skilled in the art, and the generic principles defined herein may be practiced in other embodiments without departing from the spirit or scope of the invention. Thus, the present invention is not limited to the embodiments shown herein but falls within the widest scope consistent with the principles and novel features disclosed herein.

1. A method for preparing nitrogen-containing activated carbon through ammonia activation, comprising the steps of:
heating a carbonaceous raw material up to a switching temperature under a protective atmosphere, wherein the protective atmosphere is provided by one or more of nitrogen, argon and ammonia;
switching the protective atmosphere to an activator atmosphere at the switching temperature, and then heating up to an activation temperature, wherein the activator atmosphere comprises ammonia; and
carrying out an activation reaction of the carbonaceous raw material at the activation temperature to obtain the nitrogen-containing activated carbon.

2. The method of claim 1, wherein the activator atmosphere further comprises an inert gas.

3. The method of claim 2, wherein the volume content of ammonia in the activator atmosphere is greater than or equal to 50%.

4. The method of any of claim 1, wherein the activation temperature is 800-1100° C.

5. The method of claim 4, wherein the time of the activation reaction is 0.5-5 h.

6. The method of claim 1, wherein the carbonaceous raw material is one or more of biomass based carbon, nitrogen-free activated carbon, coal and charcoal of a polymer material.

7. The method of claim 6, wherein the biomass based carbon is one or more of wood charcoal, bamboo charcoal, nut-shell charcoal, and straw charcoal.

8. The method of claim 6, wherein the polymer material is one or more of a rubber, a phenolic resin, an epoxy resin and polyurethane.

9. The method of any of claim 6, wherein the particle size of the carbonaceous raw material is ≤80 meshes.

10. The method of claim 1, wherein the heating rate at which the carbonaceous raw material is heated up to the switching temperature is 1-10° C./min.

11. The method of claim 1, wherein the heating rate at which the switching temperature is raised to the activation temperature is 1-10° C./min.

12. The method of claim 2, wherein the activation temperature is 800-1100° C.

13. The method of claim 3, wherein the activation temperature is 800-1100° C.

14. The method of claim 12, wherein the time of the activation reaction is 0.5-5 h.

15. The method of claim 13, wherein the time of the activation reaction is 0.5-5 h.

16. The method of claim 7, wherein the particle size of the carbonaceous raw material is ≤80 meshes.

17. The method of claim 8, wherein the particle size of the carbonaceous raw material is ≤80 meshes.

18. The method of claim 10, wherein the heating rate at which the switching temperature is raised to the activation temperature is 1-10° C./min.
